(19) United States
(12) Patent Application Publication
(10) Pub. No.: US 2024/0400009 A1
(43) Pub. Date: Dec. 5, 2024

(54) ELECTROMECHANICAL SERVICE BRAKE HAVING AN ELECTRICAL PARKING BRAKE, AND METHOD FOR RELEASING THE PARKING BRAKE

(71) Applicant: ZF Active Safety GmbH, Koblenz (DE)

(72) Inventors: Michael Schwarz, Koblenz (DE); Artur Schmidt, Neuwied (DE)

(21) Appl. No.: 18/678,903

(22) Filed: May 30, 2024

(30) Foreign Application Priority Data
Jun. 1, 2023 (DE) 102023114486.3

(51) Int. Cl. B60T 1/00; B60T 13/74

(52) U.S. Cl. CPC B60T 1/005; B60T 13/741; B60T 13/746

(57) ABSTRACT

The disclosure relates to an electromechanical service brake having an integrated electrical parking brake and comprising an electric motor and a control unit. The parking brake comprises a blocking element which, in an arrested state of the parking brake, blocks a transmission of the electrochemical service brake. Here, the electric motor and the transmission are surrounded by a housing which has a cutout which allows the blocking element to be manually actuated from the outside, such that the blocking element can, from the outside, be mechanically transferred from the arrested state into an opened state. In the opened state, the transmission is freely movable. The disclosure also relates to a method for emergency unlocking of such a parking brake.

### CROSS-REFERENCE TO RELATED APPLICATIONS

This application claims priority to German Application No. 102023114486.3, filed Jun. 1, 2023, the disclosure of which is incorporated herein by reference in its entirety.

### TECHNICAL FIELD

The disclosure relates to an electromechanical service brake having an integrated electrical parking brake, having an electric motor, and having a control unit. The disclosure furthermore relates to a method for emergency unlocking of a parking brake.

### BACKGROUND

Electromechanical service brakes having integrated electrical parking brakes are already known from the prior art. Faults can however occur in the electronics, with the result that the parking brake cannot be released and onward travel is prevented. Such a fault is caused for example by a defective solenoid, a defective motor, a defective control unit or an electrical failure.

The problem lies in the fact that, before the electrical parking brake is opened, the electromechanical service brake must build up a certain tension force in order to release the electrical parking brake. However, if the flow of current is prevented, this is not possible, and the parking brake cannot be released. In such a situation, it is presently necessary for the entire electrical control unit to be detached from the electromechanical service brake, or for the vehicle to be towed in order to enable it to be repaired at a workshop. This is very expensive for the vehicle owner.

### SUMMARY

What is needed is to provide an electromechanical service brake having an integrated electrical parking brake, in the case of which onward travel, at least to the nearest workshop, is made possible in the event of a blockage of the parking brake. What is also needed is a method for releasing the electrical parking brake in the event of an electrical fault, that is to say for performing emergency unlocking.

Accordingly, an electromechanical service brake having an integrated electrical parking brake and comprising an electric motor and a control unit is disclosed. The parking brake comprises a blocking element which, in an arrested state of the parking brake, blocks a transmission of the electrochemical service brake. Here, the electric motor and the transmission are surrounded by a housing which has a cutout which allows the blocking element to be manually actuated from the outside, such that the blocking element can, from the outside, be mechanically transferred from the arrested state into an opened state, wherein, in the opened state, the transmission is freely movable. In other words, the cutout allows a manual transfer from the arrested state into the opened state by manual actuation of the blocking element. The problem of a blocked parking brake can thus be quickly, easily and inexpensively resolved without the need for the vehicle to be towed.

In particular, the cutout allows access, from the outside, using a tool that is provided for actuating the blocking element. The underlying concept is accordingly that of allowing manual actuation of the blocking element in a technical emergency, by virtue of a cutout being provided in the housing of the electromechanical service brake.

In one exemplary arrangement, the electromechanical service brake furthermore comprises a cover, wherein the cover covers the cutout in the housing. The cover serves for protecting the electric motor and the transmission, and also prevents undesired direct access to the blocking element.

Here, the cover is equipped with a security lock, wherein an opening tool is required to open the cover. Inadvertent or unauthorized access is thus prevented, which protects against theft.

In one exemplary arrangement, the opening tool is a special tool that is available exclusively to breakdown services, towing services and workshops. It can thus be ensured that the parking brake can be released only by selected persons or services.

In one exemplary arrangement, an electrical actuator is provided for moving the blocking element into the arrested state and the released state. During normal operation, said electrical actuator is responsible for actuating the parking brake and providing the tension force for releasing the parking brake. The cutout thus serves merely for the transfer of the blocking element into the released state in the event of a fault of the electromechanical service brake.

In one exemplary arrangement, the actuator of the parking brake has a load-free connection to the transmission. This load-free connection allows the actuator to be uninstalled when the parking brake is in the arrested state. This is also the case because there is no electrical connection between the actuator and the electromechanical service brake. Damage to the force sensor arrangement, which would equate to a total loss, therefore does not occur during the mechanical transfer into the released state of the parking brake.

In one exemplary arrangement, the blocking element is a pawl that engages into a toothing of the transmission. For example, the pawl has a pivot bearing end, has a tooth which engages into the toothing, and has an unlocking projection which, in the arrested state, faces the cutout. The unlocking projection allows the blocking element to be easily manipulated using the tool provided for this purpose, such that a mechanical transfer into the released state is made possible in the first place.

The housing furthermore has an end wall and a side wall, wherein the side wall may have the cutout, and wherein a tool is provided which extends through the cutout to the blocking element in order to move said blocking element. For example, the end wall and the side wall have a connection to one another that cannot be non-destructively released, such that the cutout does not simply involve opening a housing cover. The cutout is accordingly only a small opening in the side wall, such that it is difficult or even impossible to access the blocking element without a tool. This, too, ensures that the parking brake can be manually transferred into the opened state only by particular persons or services. The cutout, arranged on the side wall, is nevertheless easily accessible, thus allowing the blocking element to be released.

In a further exemplary arrangement, the electromechanical service brake has a pushbutton that is accessible through the cutout in the housing. Actuation of the pushbutton causes the blocking element to be mechanically released from the arrested state. The need for a special tool for releasing the blocking element is thus eliminated, and the entire process of releasing the blocking element is simplified. For this exemplary arrangement, however, a cover having a security lock is used in order to provide increased protection against theft by unauthorized actuation.

The problem is furthermore solved by a method for emergency unlocking of a parking brake, wherein the parking brake is integrated in an electromechanical service brake, for example an electromechanical service brake according to the disclosure. Here, an electric motor and a transmission of the electromechanical service brake are surrounded by a housing that has a cutout, wherein a blocking element of the parking brake is, from the outside through the cutout, mechanically released from an arrested state in which the blocking element blocks the transmission. In other words, the parking brake can be unlocked in an emergency by virtue of the blocking element being mechanically released.

A tool, for example an individual special tool, is used for releasing the actuator, wherein the tool is used to pivot a pawl of the transmission out of engagement with the transmission. This is possible because the transmission is load-free, such that the release of the blocking element does not result in a total loss of the sensor arrangement. A special tool is a tool which is not defined in standards, and which is therefore not commercially available in hardware stores or in the tool trade.

The electromechanical service brake furthermore comprises a cover for covering the cutout, such that the cover must firstly be removed from the cutout before the parking brake can be released. As already mentioned, the cover serves for protecting against an ingress of dirt and moisture and for protecting against theft, because access to the blocking element and thus to the parking brake is impeded, such that only selected persons or services can gain access.

### BRIEF DESCRIPTION OF THE DRAWINGS

Further advantages and features of the disclosure will emerge from the following description and from the appended drawings, to which reference is made. In the drawings:

FIG. 1 shows a perspective view of an electromechanical service brake having an integrated electrical parking brake;

FIG. 2 shows a perspective view of an electromechanical service brake according to the disclosure having an integrated electrical parking brake, with the cover of the cutout having been opened;

FIG. 3 shows a perspective view with a cutout according to the disclosure, into which an opening tool has been inserted;

FIG. 4 shows a perspective view into the interior of the electrical parking brake after an end wall has been removed;

FIG. 5 shows further a perspective view into the interior of the electrical parking brake; and

FIG. 6 shows a perspective view into the interior of the electrical parking brake, with a blocking element having been released.

### DETAILED DESCRIPTION

FIG. 1 shows an electromechanical service brake 10 according to the disclosure which has an integrated electrical parking brake 12. Here, the parking brake 12 and an electric motor 14 and a control unit 16 are surrounded by a housing 18.

The housing 18 is screwed to a carrier 19 of the electromechanical service brake 10 and comprises an end wall 20 and a side wall 22. The end wall 20 and the side wall 22 have a connection to one another that cannot be non-destructively released. This means that the end wall 20 cannot simply be separated from the side wall 22 without damage being caused to the parking brake 12 or to at least the housing 18 thereof.

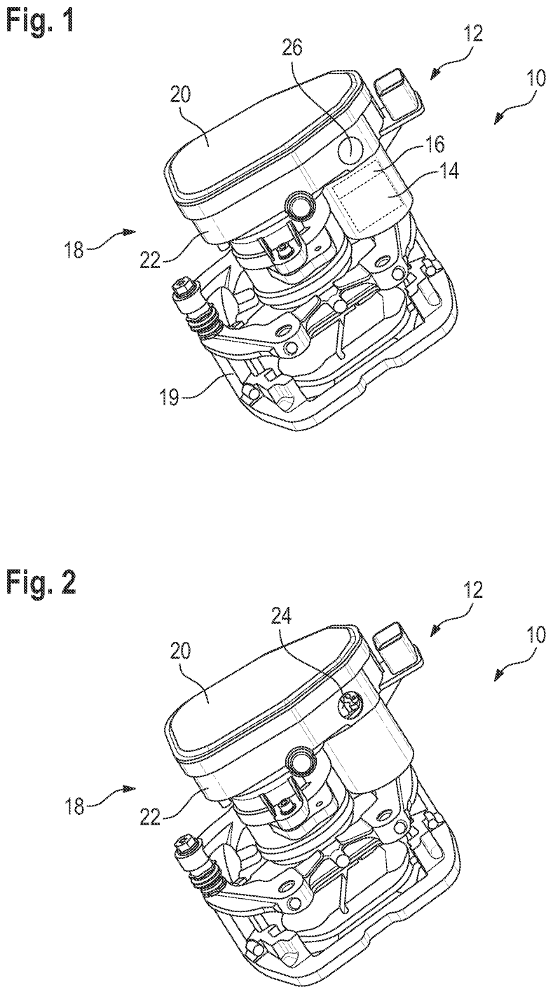

The side wall 22 furthermore has a cutout 24 that is covered by a cover 26. FIG. 2 shows the cutout 24 without the cover 26.

The cover 26 is equipped with a security lock (not illustrated here) in order to ensure a certain degree of protection against inadvertent and unauthorized opening. Accordingly, an opening tool, which is in principle a special tool, is required to open the cover 26. The security lock may for example involve a coding as in the case of a locking wheel bolt or nut. Alternatively, the cover 26 may be designed such that it can be released only using a key, for example, the vehicle key, similar to a fuel-tank lock.

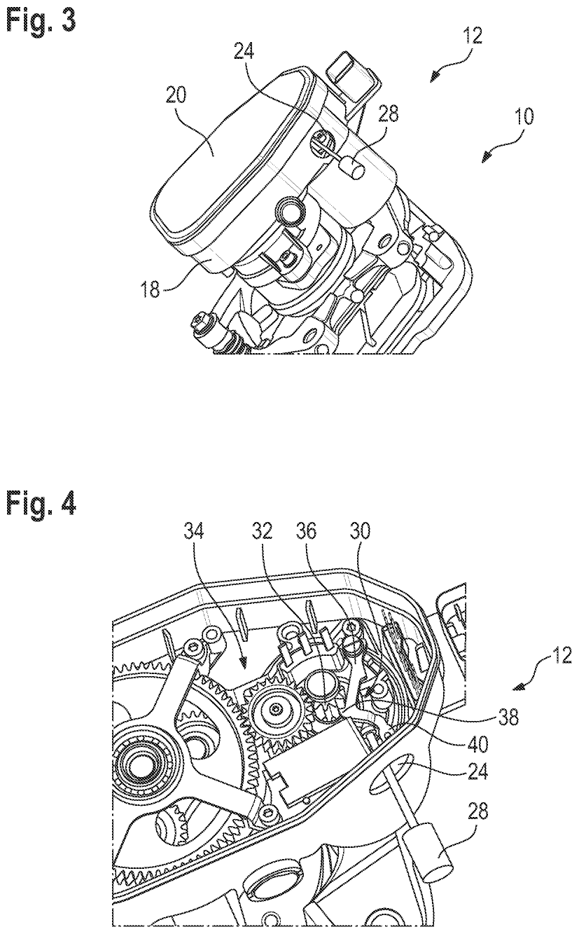

FIG. 3 shows how a tool 28 is introduced into the cutout in order to transfer the parking brake into the opened state.

In one exemplary arrangement, the tool 28 may be a special tool that is available exclusively to breakdown services, towing services and workshops. This is intended to ensure that not anyone can transfer the parking brake 12 from the arrested state into the opened state and, amongst other things, protects against theft.

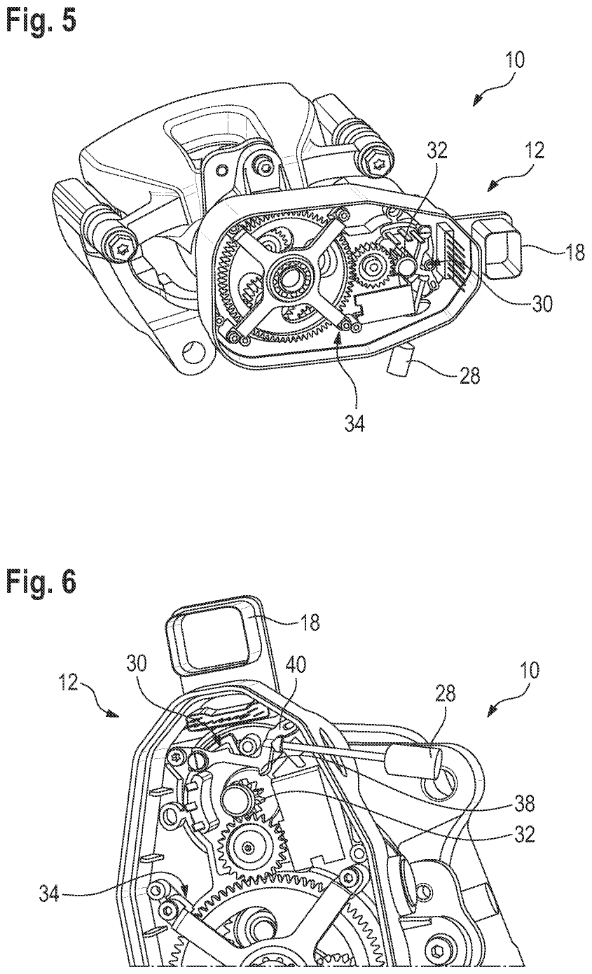

FIGS. 4 to 6 show the housing 18 without the end wall 20, such that the mechanism of the parking brake 12 is visible. For example, the parking brake 12 comprises a single-armed lever that forms a blocking element 30; in the closed state, said blocking element engages into a toothing 32 of the transmission 34 of the electromechanical service brake 10 and thus blocks the electromechanical service brake 10 in an effective manner. This arrested state of the electrical parking brake 12 can be seen for example in FIG. 4.

A pivoting drive for the blocking element 30 is seated below the transmission shown in FIG. 4.

In the exemplary arrangement shown here, the blocking element 30 is a pawl having a pivot bearing end 36 and having a tooth 38 that engages into the toothing 32 of the transmission 34. The pawl furthermore has an unlocking projection 40 in a region which is remote from the tooth 38 and which, compared to the tooth 38, is situated further away from the pivot bearing end 36. In the arrested state, said unlocking projection 40 faces the cutout 24.

In the event of a fault of the parking brake, the cutout 24 allows the blocking element 30 to be manually actuated from the outside in order to transfer the parking brake 12 into the opened state. Such a fault may be caused for example by a defective solenoid, a defective electric motor 14, a defective control unit 16 or an electrical failure.

The problem in the event of such a fault in the electronics lies in the residual clamping forces that arise in the blocked state of the parking brake 12. These residual clamping forces may lie in the kN range and thus render onward travel impossible. Since the transmission 34 is however load-free, the residual clamping forces can be mechanically reduced from the outside without the force sensor arrangement being damaged in the process. A total loss is thus prevented, and onward travel is made possible relatively quickly.

To open the parking brake 12, it is thus necessary for a tension force to be built up by the electromechanical service brake 10, which is no longer possible in the event of such a defect.

In such a situation, the cover 26 of the cutout 24 can now be removed such that the tool 28 can be inserted through the cutout 24 into the interior of the housing 18. The tool 28 can thus interact with the unlocking projection 40 and release the blocking element 30 from the toothing 32. This thus constitutes a manual actuation of the blocking element 30, wherein the blocking element 30 is, from the outside, mechanically transferred from the arrested state into the opened state. The opened state can be seen in FIG. 6.

In an exemplary arrangement that is not shown in the figures, the electromechanical service brake 10 has a pushbutton. Here, the pushbutton is arranged in the interior of the housing 18 and can be accessed through the cutout 24 in the housing 18.

The pushbutton is coupled to the blocking element 30 such that depressing the pushbutton causes the blocking element 30 to be mechanically transferred from the closed state into the opened state and the transmission 34 to be released.

It is important here that the cover 26 of the cutout 24 is adequately secured in order to ensure protection against theft. For this reason, a further cover may also be provided for the pushbutton.

Alternatively, provision may also be made for the pushbutton to be positioned in the interior of the housing 18 such that a tool 28 is required to actuate the pushbutton.

1. An electromechanical service brake having an integrated electrical parking brake, comprising an electric motor and a control unit, wherein the parking brake comprises a blocking element which, in an arrested state of the parking brake, blocks a transmission of the electrochemical service brake, wherein the electric motor and the transmission are surrounded by a housing which has a cutout which allows the blocking element to be manually actuated from the outside, such that the blocking element can, from the outside, be mechanically transferred from the arrested state into an opened state, wherein, in the opened state, the transmission is freely movable.

2. The electromechanical service brake according to claim 1, wherein the electromechanical service brake furthermore comprises a cover, wherein the cover covers the cutout in the housing.

3. The electromechanical service brake according to claim 2, wherein the cover is equipped with a security lock, wherein an opening tool is required to open the cover.

4. The electromechanical service brake according to claim 1, wherein an electrical actuator is provided for moving the blocking element into the arrested state and the released state.

5. The electromechanical service brake according to claim 4, wherein the actuator of the parking brake has a load-free connection to the transmission.

6. The electromechanical service brake according to claim 1, wherein the blocking element is a pawl, wherein the pawl engages into a toothing of the transmission.

7. The electromechanical service brake according to claim 1, wherein the housing has an end wall and a side wall, and the side wall has the cutout, wherein a tool, in particular an individual special tool, is provided which extends through the cutout to the blocking element in order to move said blocking element.

8. A method for emergency unlocking of a parking brake, wherein the parking brake is integrated in an electromechanical service brake, the method comprising providing an electromechanical service brake according to claim 1, wherein an electric motor and a transmission of the electromechanical service brake are surrounded by a housing that has a cutout, mechanically releasing a blocking element of the parking brake, from the outside through the cutout, from an arrested state in which the blocking element blocks the transmission.

9. The method according to claim 8, further comprising using a tool to release the blocking element, wherein the tool is used to pivot the blocking element out of engagement with the transmission.

10. The method according to claim 8, removing a cover from the electromechanical service brake to expose the cutout, before releasing the blocking brake.

11. A tool for an electromechanical service brake according to claim 7.

12. The electromechanical service brake according to claim 6, wherein the pawl has a pivot bearing end, has a tooth which engages into the toothing, and has an unlocking projection which, in the arrested state, faces the cutout.

13. The electromechanical service brake according to claim 7, wherein the tool is provided which extends through the cutout to the blocking element in order to move said blocking element.

14. The method according to claim 9, removing a cover from the electromechanical service brake to expose the cutout, before releasing the blocking brake.
